(19) United States
(12) Patent Application Publication
(10) Pub. No.: US 2014/0313886 A1
(43) Pub. Date: Oct. 23, 2014

(54) PROTECTION IN A RING NETWORK OF LABEL SWITCHING ROUTERS

(71) Applicants: Song Yuan, Beijing (CN); Giovanni Mumolo, Beijing (CN)

(72) Inventors: Song Yuan, Beijing (CN); Giovanni Mumolo, Beijing (CN)

(73) Assignee: TELEFONAKTIEBOLAGET L M ERICSSON (PUBL), Stockholm (SE)

(21) Appl. No.: 14/354,920

(22) PCT Filed: Oct. 28, 2011
(86) PCT No.: PCT/CN2011/001804

§ 371 Date: Apr. 28, 2014

(51) Int. Cl. H04L 12/703; H04L 12/723

(52) U.S. Cl. CPC H04L 45/28; H04L 45/50
USPC 370/228

(57) ABSTRACT

A first label switch router (LSR) in a ring network protects multiple service label switched paths (LSPs) using a single bidirectional circular protection LSP tunnel. The first LSR monitors for a failure report responsive to detecting disconnection with a neighbor LSR. The report indirectly indicates either failure of a link to the neighbor LSR or failure of the neighbor LSR itself. Responsive to receiving the report, the first LSR locally re-routes any labeled packets of service LSPs headed toward the failure by placing those packets onto the tunnel in a direction away from the failure, and locally merges any labeled packets received over the tunnel into respective service LSPs headed away from the failure. Local re-routing entails the first LSR dynamically selecting between next-hop service labels and next-next-hop service labels for packets placed onto the tunnel, based on whether the failure is of the link or of the neighbor LSR.

### TECHNICAL FIELD

The present invention generally relates to protecting service label switched paths (LSPs) in a ring network, and particularly relates to protecting multiple service LSPs against any single network element failure with a single bidirectional circular protection LSP tunnel.

### BACKGROUND

Multi-Protocol Label Switching (MPLS) is a data-carrying mechanism that improves the forwarding performance of packet-switched networks, such as Internet Protocol (IP) networks. In MPLS, ingress label edge routers (LERs) analyze the IP header of packets entering the network and attach to those packets labels that are bound to label switched paths (LSP) pre-established through the network. Packets that have the same label will generally follow the same LSP through the network because those packets are routed through the network by label switching routers (LSRs) based solely on the packets' labels, not the packets' IP headers. Having traversed the network, egress LERs remove the packets' labels and distribute the packets onward based on their IP headers.

MPLS networks guard against the failure of network elements, such as links between LSRs and LSRs themselves, by employing a local protection mechanism called Fast Re-Route (FRR). FRR relies on backup LSPs (also called protection LSPs) that have been pre-established to carry the traffic of primary LSPs (also called service LSPs) around network elements subject to failure. When an LSR detects a failure affecting a service LSP, that LSR (known as the point of local repair) locally re-directs the labeled packets of that service LSP to a protection LSP that bypasses the failure. The protection LSP intersects the service LSP at some LSR downstream from the failure, and that downstream LSR (known as the merge point) locally merges the labeled packets back to the service LSP. Because the re-direction and merge decisions are strictly local to an LSR, FRR provides faster recovery from failure than recovery mechanisms at the IP layer.

FRR was described above as using protection label switching. According to protection label switching, the point of local repair switches a service label for a protection label, and the merge point reverts back to a service label. FRR can alternatively exploit protection label stacking to bypass a failure. According to protection label stacking, the point of local repair pushes a protection label on top of a service label, and the merge point pops the protection label back off to reveal the service label. Such stacking effectively creates a so-called protection LSP “tunnel” between the point of local repair and the merge point, as LSRs between those points perform label switching based solely on the protection label, not the underlying service label.

Protection LSP tunnels prove particularly useful in protecting MPLS networks that have ring topologies. Yet some known approaches to such protection require significant label resources because they require the establishment of a large number of protection LSP tunnels. Indeed, those approaches require that separate protection LSP tunnels be specifically established for each service LSP and/or network element to be protected. Other known approaches that require fewer label resources waste processing resources because they trigger infinite protection LSP tunnel loops upon the occurrence of multiple network element failures.

### SUMMARY

Embodiments herein advantageously protect multiple service LSPs that traverse a ring network against any single network element failure using a single bidirectional circular protection LSP tunnel. LSRs that have detected the existence of a network element failure condition their use of the tunnel on the receipt of a failure report that indirectly indicates the type of the detected failure. Utilization of only a single tunnel conserves label resources, while conditional initiation of local protection prevents tunnel loops upon the occurrence of multiple failures.

More particularly, embodiments herein include processing for protecting multiple service LSPs with a single bidirectional circular protection LSP tunnel established around the ring network in advance of any failure. The processing is performed by a first LSR and includes monitoring for a failure report responsive to detecting disconnection with a neighbor LSR. The failure report monitored for either indirectly indicates failure of a link to the neighbor LSR by reporting complementary disconnection with the first LSR or indirectly indicates failure of the neighbor LSR itself by confirming disconnection with the neighbor LSR.

In either case, processing further includes, responsive to receiving the report, locally re-routing any labeled packets of service LSPs headed toward the failure by placing those packets onto the tunnel in a direction away from the failure (i.e., by serving as a point of local repair for service LSPs headed toward the failure). Notably, packets are placed onto the tunnel with either next-hop service labels or next-next-hop service labels depending on whether the failure is of the link or of the neighbor LSR. Finally, processing responsive to receipt of the failure report further includes locally merging any labeled packets received over the tunnel into respective service LSPs headed away from the failure (i.e., serving as a merge point for service LSPs headed away from the failure).

Note that such processing conditions the first LSR's initiation of local protection (i.e., re-routing and merging) on receipt of the failure report, rather than simply detection of disconnection with the neighbor LSR. Conditioning local protection in this way advantageously prevents tunnel loops upon the occurrence of multiple network element failures. Indeed, if multiple failures in the network occur, the first LSR will not receive a failure report related to the neighbor LSR and thus will refrain from unproductively initiating local protection.

Note also that analogous processing will be performed simultaneously by another operational LSR on the opposite side of the failure. This other LSR will be either the neighbor LSR, if the failure is of the link between the first LSR and the neighbor LSR, or will be the neighbor LSR's other neighbor over the ring network, if the failure is of the neighbor LSR itself. In this context, therefore, processing at the first LSR may further include sending a report around the ring network that reports disconnection with the neighbor LSR, to thereby indirectly indicate to the other operational LSR whether disconnection detected by that LSR is attributable to a link failure or a node failure.

In at least some embodiments, local re-routing is governed by re-routing rules that are locally generated in advance of failure. An LSR locally generates these re-routing rules based on one or more label advertisements received from a neighbor LSR that advertise the next-hop service labels and next-next-hop service labels for service LSPs headed toward that neighbor LSR. In some embodiments, the LSRs are configured to propagate the above label advertisements amongst themselves responsive to establishment of the protection LSP tunnel, and to then locally generate the re-routing rules responsive to receipt of the label advertisements.

In this regard, the LSRs in some embodiments are configured to automatically establish the tunnel in advance of any failure, by locally coordinating with their neighbor LSRs usage of direction-specific protection labels for the tunnel. Such coordination may entail, for instance, exchanging protection label offers and responses with neighbor LSRs.

The various reports, advertisements, offers, responses, and messages described herein may be communicated between LSRs in the network via any number of possible communication mechanisms, According to at least one embodiment, though, they are communicated within different types of protection coordination messages that are sent over the tunnel on an in-band control channel. As just one example of these embodiments, an LSR that has detected disconnection with a neighbor LSR monitors protection state coordination messages received over the tunnel on an in-band control channel for a particular type of message that is identified as a failure report.

Use of protection coordination messages and an in-band control channel proves to advantageously minimize the control signaling complexity involved in tunnel establishment, re-route rule generation, and local protection initiation. Minimizing control signaling complexity in this way correspondingly reduces demands on LSR capabilities, so that the embodiments herein are sufficiently light-weight to be applied to low-end LSRs within an access network.

Indeed, according to embodiments herein, LSRs need not even have the IP capabilities traditionally required to negotiate protection labels over a Resource Reservation Protocol (RSVP) session.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a ring network 10 of label switching routers (LSRs) according to one or more embodiments herein,

FIG. 2 is a logic flow diagram of processing performed by an LSR for protecting multiple service label switched paths (LSPs) with a single bidirectional circular protection LSP tunnel, according to one or more embodiments.

FIGS. 3A-3F is a block diagram that illustrates the processing of FIG. 2 in the context of an example, where FIGS. 3C and 3D exemplify processing performed in the event of link failure, and FIGS. 3E and 3F exemplify processing performed in the event of node failure.

FIG. 4 is a block diagram that illustrates automatic tunnel configuration in the context of an example.

FIG. 5 is a block diagram that illustrates designated router election in the context of an example.

FIGS. 6A-6E are block diagrams of the structure of labeled packets that convey various types of protection coordination messages over the protection LSP tunnel on an in-band control channel.

FIG. 7 is a block diagram of an LSR in the ring network that is configured to protect multiple service label switched paths (LSPs) with a single bidirectional circular protection LSP tunnel, according to one or more embodiments.

### DETAILED DESCRIPTION

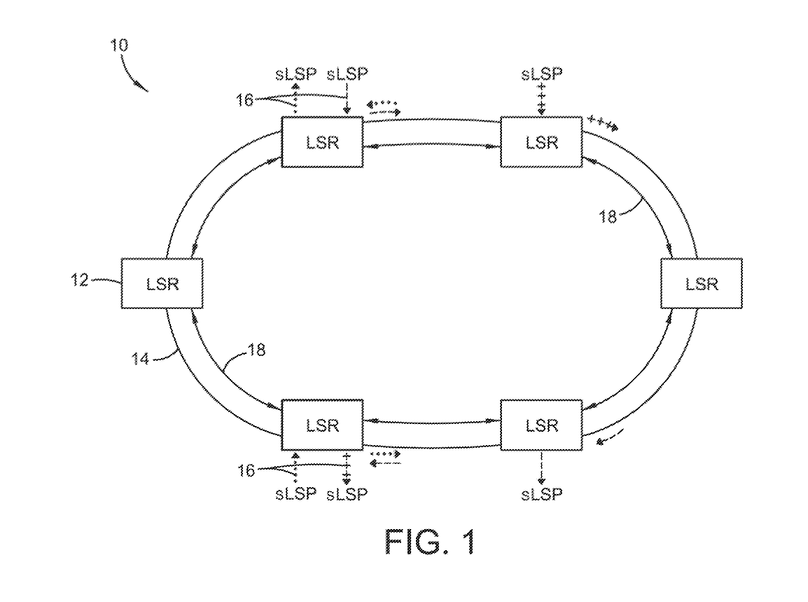

FIG. 1 depicts a ring network 10 according to one or more embodiments. The elements that form the network 10 include label switching routers (LSRs) 12 (also referred to as nodes or hosts) and bidirectional communication links 14 that interconnect the LSRs 12 in a ring topology, The LSRs 12 route packets through the network 10, over the links 14, by performing label switching and/or stacking with respect to labels attached to those packets.

In this regard, service labels are bound to service label switched paths (LSPs) 16 that have been pre-established through the network 10 as the primary paths that labeled packets will follow through the network 10. An LSR 12 generally performs switching with respect to these labels by identifying the service LSP 16 that is locally bound to an existing service label of a received packet, switching that label for a different service label that is bound to the identified service LSP 16 by a next-hop LSR, and forwarding the packet to the next-hop LSR. Labeled packets propagate along their respective LSPs 16 in this way unless and until an element employed by those LSPs, such as an LSR 12 or a link 14 between LSRs 12, fails.

The network 10 advantageously protects the multiple service LSPs 16 against any such failure by using a single bidirectional circular protection LSP tunnel 18 to wrap or otherwise carry labeled packets around that failure and then merge the packets back onto their respective service LSPs 16. Although the tunnel 18 is pre-established around the network 10 in advance of failure, the tunnel 18 is not tailored to protect any specific service LSP 16 or to protect against the failure of any specific network element. Rather, the tunnel 18 is generically established to protect any of the multiple service LSPs 16 against the failure of any network element. To this end, the bidirectional nature of the tunnel 18 enables it to protect service LSPs 16 headed in different directions, while the circular nature of the tunnel 18 enables it to generically protect against the failure of different network elements. Because the network 10 employs only a single tunnel 18 in this regard, rather than multiple different tunnels for different service LSPs 16 or network element failures, the network 10 conserves label resources.

Given this generic establishment of the tunnel 18, the particular LSRs 12 that actively serve as tunnel endpoints to wrap labeled packets around a network element failure will dynamically vary depending on which network element has failed. In general, operational LSRs 12 that are on opposite sides of the network element failure will be dynamically triggered to serve as effective tunnel endpoints that respectively place labeled packets onto and take labeled packets off of the tunnel 18. In particular, the tunnel endpoint placing labeled packets of a particular LSP 16 onto the tunnel 18 (also referred to as the point of local repair for that LSP 16) intelligently selects the service labels with which those packets are to be sent over the tunnel 18 In doing so, the point of local repair selects service labels that are bound to the particular LSP 16 by the other tunnel endpoint taking labeled packets off of the tunnel (also referred to as the merge point). Those service labels will be either next-hop service labels for the LSP 16, or next-next-hop service labels for the LSP 16, depending on whether the failed network element between the point of local repair and the merge point is a link or a node. Note of course that, due to the bidirectional nature of the tunnel 18, any given LSR 12 may serve as the point of local repair for LSPs headed in one direction around the network 10, while serving as the merge point for other LSPs headed in the opposite direction. Thus, operational LSRs 12 on opposite sides of the network element failure target each other as effective tunnel endpoints by placing labeled packets onto the tunnel with service labels recognized by each other.

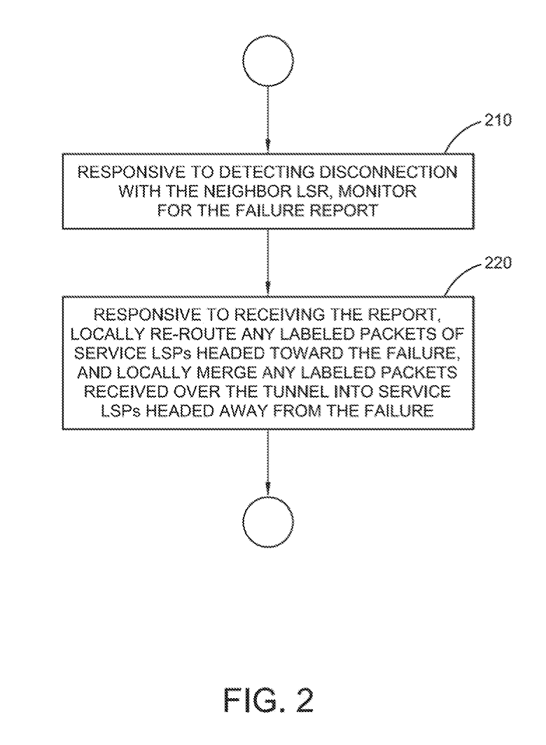

In view of the above, FIG. 2 illustrates processing steps performed by an LSR 12 in the network 10 (referred to for convenience simply as the first LSR) for serving as one tunnel endpoint that protects the service LSPs 16 against network element failure. As shown in FIG. 2, responsive to detecting disconnection with a neighbor LSR 12, processing at the first LSR 12 entails monitoring for a failure report (Block 210). This failure report either indirectly indicates failure of a link to the neighbor LSR 12 by reporting complementary disconnection with the first LSR, or indirectly indicates failure of the neighbor LSR itself by confirming disconnection with the neighbor LSR.

Then, responsive to receiving the failure report, processing includes locally re-routing any labeled packets of service LSPs 16 headed toward the failure by placing those packets onto the tunnel 18 in a direction away from the failure (i.e., by serving as a point of local repair for service LSPs headed toward the failure) (Block 220). Notably, packets are placed onto the tunnel 18 with either next-hop service labels or next-next-hop service labels depending on whether the failure is of the link or of the neighbor LSR. Finally, processing responsive to receipt of the failure report further includes locally merging any labeled packets received over the tunnel into respective service LSPs 16 headed away from the failure (i.e., serving as a merge point for service LSPs headed away from the failure). Note that such processing conditions the first LSR's initiation of local protection (i.e., re-routing and merging) on receipt of the failure report, rather than simply detection of disconnection with the neighbor LSR. Conditioning local protection in this way advantageously prevents tunnel loops upon the occurrence of multiple network element failures. Indeed, if multiple failures in the network 10 occur, the first LSR will not receive a failure report related to the neighbor LSR and thus will refrain from unproductively initiating local protection.

Note also that analogous processing will be performed simultaneously by another operational LSR 12 in the network 10 that serves as the other tunnel endpoint. This other LSR 12 will be either the neighbor LSR, if the failure is of the link between the first LSR and the neighbor LSR, or will be the neighbor LSR's other neighbor, if the failure is of the neighbor LSR itself. In this context, therefore, processing at the first LSR may further include sending a report around the ring network 10 that reports disconnection with the neighbor LSR, to thereby indirectly indicate to the other tunnel endpoint whether disconnection detected by that endpoint is attributable to a link failure or a node failure.

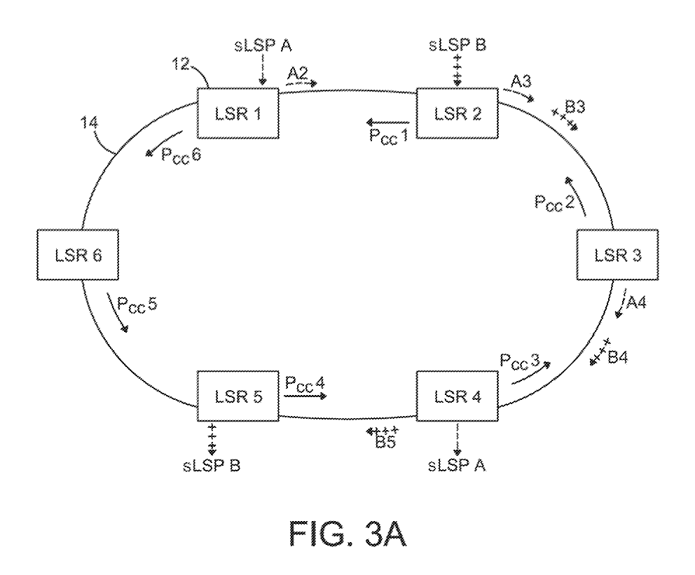

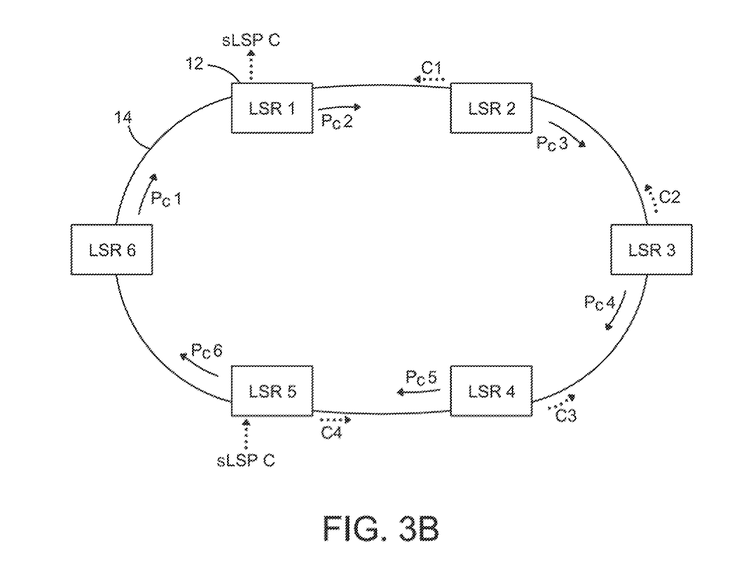

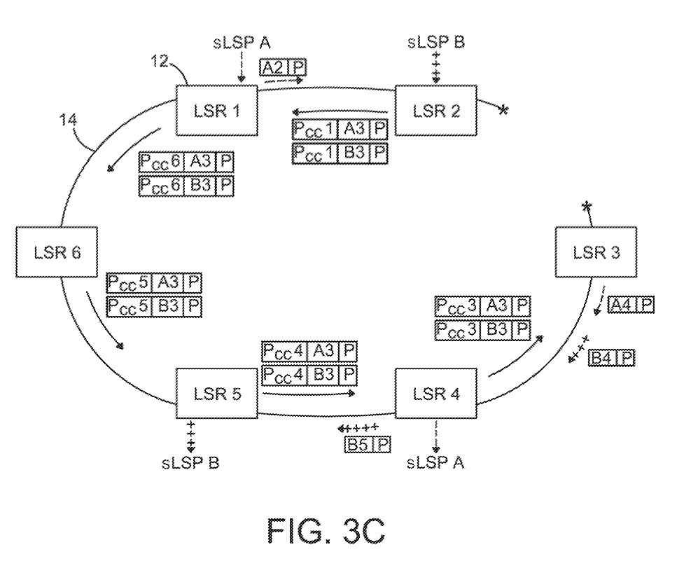

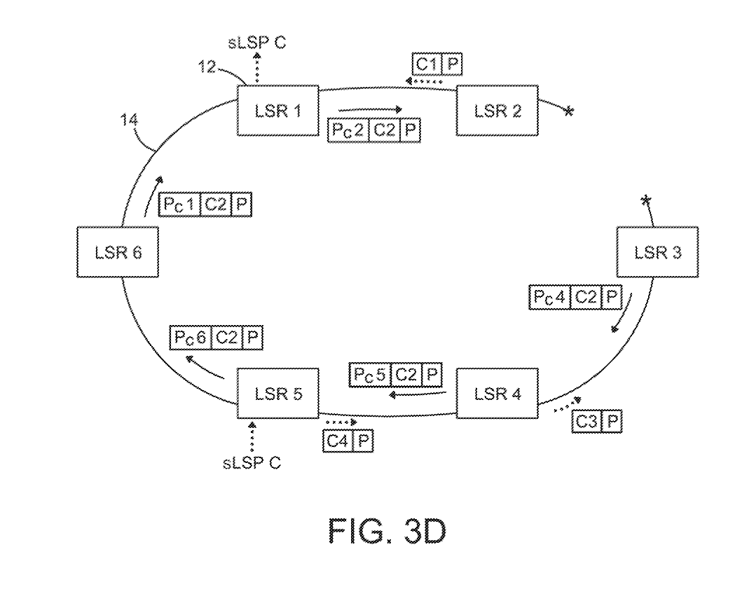

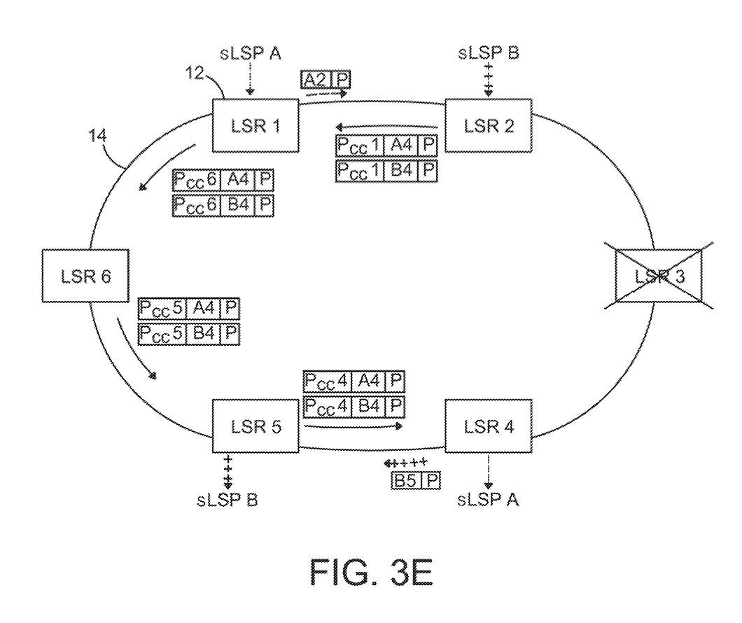

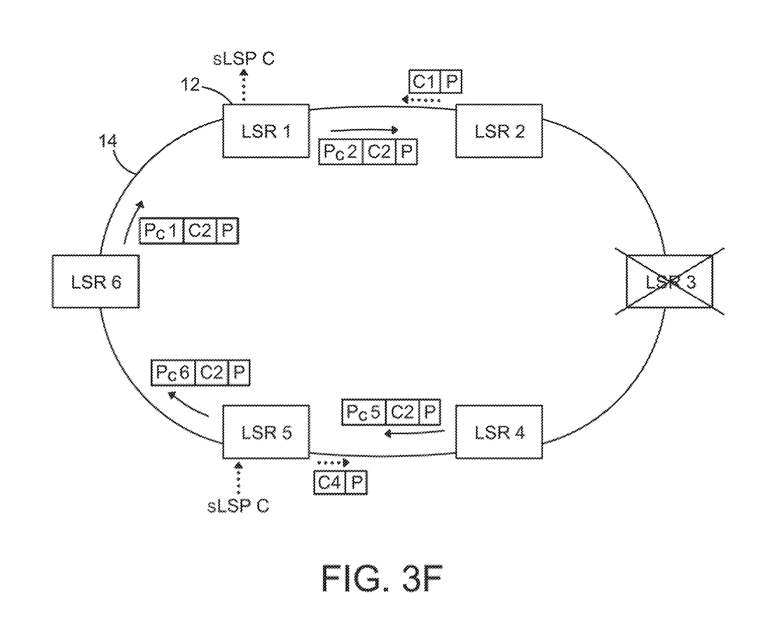

FIGS. 3A-3F illustrate the above processing in the context of a simple example. FIGS. 3A and 3B illustrate three service LSPs A, B, and C, and the bidirectional circular protection LSP tunnel 18. This tunnel 18 is formed in one direction through protection labels Pcc1-Pcc6 and in the other direction through protection labels Pc1-Pc6 More specifically, FIG. 3A illustrates service LSPs A and B that traverse the ring network 10 in the clockwise direction, and also illustrates the tunnel 18 as it is established in the counterclockwise direction, Conversely, FIG. 3B illustrates service LSP C that traverses the ring network 10 in the counterclockwise direction, and also illustrates the tunnel 18 as it is established in the clockwise direction.

Describing the service LSPs in more detail, labeled packets of service LSP A enter the network 10 at LSR 1 and exit the network 10 at LSR 4. In the absence of any network failure, LSR 1 labels packets of service LSP A with service label A2 and forwards them to the next-hop, namely LSR 2. LSR 2 identifies those packets as belonging to LSP A, swaps service label A2 for service label A3, and forwards the packets to the next-hop, namely LSR 3. LSR 3 in turn identifies the packets as belonging to LSP A, swaps service label A3 for service label A4, and forwards the packets to LSR 4, where they exit the network 10. In a similar manner, labeled packets of service LSP B enter the network 10 at LSR 2, travel from LSR 2 to LSR 3 with label B3, from LSR 3 to LSR 4 with label B4, from LSR 4 to LSR 5 with label B5, and then exit the network 10 at LSR 5. Finally, labeled packets of service LSP C enter the network 10 at LSR 5, travel from LSR 5 to LSR 4 with label C4, from LSR 4 to LSR 3 with label C3, from LSR 3 to LSR 2 with label C2, from LSR 2 to LSR 1 with label C1, and then exit the network 10 at LSR 1.

Labeled packets propagate along their respective LSPs in this way unless and until an element employed by those LSPs, such as the link between LSR 2 and LSR 3, or LSR 3 itself, fails. The network 10 of course protects the service LSPs against any such failure by using the pre-established tunnel 18 to wrap and re-route labeled packets around the failure and then merge the packets back onto their respective service LSP. In this regard, FIG. 3A shows that the LSRs have negotiated protection labels Pcc1-Pcc6 to pre-establish the tunnel in the counterclockwise direction. Conversely, FIG. 38 shows that the LSRs have negotiated protection labels Pc1-Pc6 to pre-establish the tunnel in the clockwise direction.

FIGS. 3C and 3D illustrate an example where the link between LSR 2 and LSR 3 fails. When this occurs, LSR 2 detects disconnection with LSR 3, and LSR 3 detects complementary disconnection with LSR 2. Responsive to detecting disconnection, LSR 2 generates a report reporting that it has detected disconnection with LSR 3, and sends that report around the network 10. Likewise, LSR 3 generates a report reporting that it has detected disconnection with LSR 2, and sends the report around the network 10

In at least some embodiments, these reports are generically targeted for any other LSR that has detected disconnection with one of its neighbor LRSs, meaning that they are not specifically addressed to any particular LSR. Thus, the report generated by LSR 2 is not addressed specifically to LSR 3, and the report generated by LSR 3 is not addressed specifically to LSR 2.

With such generically targeted failure reports, LSRs that have not detected disconnection with a neighbor LSR simply forward received reports on around the ring network 10 without inspecting them. But LSRs that have detected disconnection with a neighbor LSR, like LSR 2 and LSR 3, specifically monitor for such reports. Indeed, combined with each LSR's own disconnection detection, the report from LSR 3 indirectly indicates to LSR 2 that the link between LSRs 2 and 3 has failed. and the report from LSR 2 likewise indirectly indicates to LSR 3 that such link has failed.

Responsive to receiving a failure report, LSR 2 and LSR 3 initiate local protection to wrap labeled packets of service LSPs A, B, and C around the faulty link between them. Consider service LSP A in FIG. 3C. As shown, a labeled packet of service LSP A travel from LSR 1 to LSR 2 with its payload (P) encapsulated by service label A2. Under normal circumstances, the packet would then be headed toward LSR 3. But, rather than attempting to forward that packet to LSR 3 over the faulty link, LSR 2 locally re-routes the packet by placing that packet onto the tunnel in a direction away from the faulty link (i.e., by serving as a point of local repair for service LSP A).

Notably, LSR 2 is configured to place the packet onto the tunnel with either service label A3, which is the next-hop service label for LSP A, or service label A4, which is the next-next-hop service label for LSP A, depending on whether the link between LSR 2 and LSR 3 has failed or LSR 3 itself has failed. Because the link between LSR 2 and LSR 3 has failed rather than LSR 3 itself failing, LSR 2 places the packet onto the tunnel with service label A3. To do so, LSR 2 swaps service label A2 for service label A3, pushes protection label Pool on top of that service label, and forwards the packet back toward LSR 1. The labeled packet then travels counterclockwise from LSR 1 to LSR 3 over the protection LSP tunnel, as those LSRs simply perform label switching with respect to the protection labels at the top of the packet's label stack.

Because LSR 3 has initiated local protection responsive to receipt of the failure report from LSR 2, LSR 3 serves as the merge point for LSP A by taking the packet off of the tunnel and locally merging the packet back into service LSP A. To do so, LSR 3 pops the protection label Pcc3 at the top of the packet's label stack and performs normal label switching with respect to the underlying service label A3 by swapping that service label for service label A4,

The LSRs use the same protection tunnel to wrap labeled packets of LSP B around the faulty link. Thus, LSR 2 also serves as the point of local repair for LSP B, and LSR 3 also serves as the merge point for LSP B.

Moreover, as shown in FIG. 3D, the LSRs even use the same protection tunnel to wrap labeled packets of LSP C around the faulty link, despite that LSP being established in the opposite direction. The fact that LSP C is established in the opposite direction simply means that the LSRs use the tunnel's counterclockwise protection labels Pc1-Pc6 for sending packets over the tunnel, rather than the tunnel's clockwise protection labels Pcc1-Pcc6, and that the roles of LSR 2 and LSR 3 are reversed in terms of which LSR serves as the point of local repair and the merge point.

Accordingly, in FIG. 3D, labeled packets of service LSP C travel from LSR 5 to LSR 3 and are headed toward the faulty link between LSR 2 and LSR 3. But, rather than attempting to forward that packet to LSR 2 over the faulty link, LSR 3 locally re-routes the packet by placing that packet onto the tunnel in a direction away from the faulty link (Le., by serving as a point of local repair for service LSP C). LSR 3 is configured to place the packet onto the tunnel with either service label C2, which is the next-hop service label for LSP C, or with service label C1, which is the next-next-hop service label for LSP C, depending on whether the link between LSR 2 and LSR 3 has failed or LSR 2 itself has failed Because the link between LSR 2 and LSR 3 has failed rather than LSR 2 itself failing, LSR 3 places the packet onto the tunnel with service label C2. To do so, LSR 3 swaps service label C3 for service label C2, pushes protection label Pc4 on top of that service label, and forwards the packet back toward LSR 4. The labeled packet then travels clockwise from LSR 4 to LSR 2 over the tunnel, as those LSRs simply perform label switching with respect to the protection labels at the top of the packet's label stack.

Because LSR 2 has initiated local protection responsive to receipt of he failure report from LSR 3, LSR 2 serves as the merge point for LSP C by taking the packet off of the tunnel and locally merging the packet back into service LSP C. To do so, LSR 2 pops the protection label Pc2 at the top of the packet's label stack and performs normal label switching with respect to the underlying service label C2 by swapping that service label for service label C1.

FIGS. 3E and 3F by contrast illustrate an example where LSR 3 itself has failed rather than just the link between LSR 2 and LSR 3. In this case, LSR 2 and LSR 4 are the LSRs that effectively exchange failure reports and initiate local protection responsive to receipt of those reports. By initiating local protection, LSR 2 and LSR 4 wrap labeled packets of service LSPs A, B, and C around the faulty LSR.

Local protection proceeds analogously to the link failure example above, except that the point of local repair places labeled packets onto the tunnel with next-next-hop service labels rather than next-hop service labels, because the failure is of LSR 3 itself rather than the link between LSR 2 and LSR 3. FIG. 3E, for instance, illustrates LSR 2 placing labeled packets for service LSPs A and B onto the tunnel with service labels A4 and B4, which are the next-next-hop service labels for those LSPs.

In at least some embodiments, local re-routing is governed by re-routing rules that are locally generated in advance of failure. An LSR 12 locally generates these re-routing rules based on one or more label advertisements received from a neighbor LSR that advertise the next-hop service labels and next-next-hop service labels for service LSPs 16 headed toward that neighbor LSR. Based on such label advertisement, the re-routing rules specify that, if the LSR becomes a point of local repair due to link failure occurring in the direction of the neighbor LSR, the LSR is to place packets onto the tunnel 18 with the next-hop service labels advertised, Conversely, the re-routing rules specify that, if the LSR becomes a point of local repair due to node failure occurring in the direction of the neighbor LSR, the LSR is to instead place packets onto the tunnel 18 with the next-next-hop service labels advertised.

In embodiments based on Multi-Protocol Label Switching (MPLS), these locally generated re-routing rules are referred to as Fast Re-Route (FRR) objects. Unlike conventional MPLS networks that remotely generate FRR objects at one LSR and propagate that object hop-by-hop to other LSRs, MPLS-based embodiments herein locally generate FRR objects at each

LSR based on received label advertisements. For each service LSP, the LSR locally generates first and second FRR objects. The first FRR object generated is configured to place labeled packets of the service LSP onto the tunnel 18 with an advertised next-hop service label, while the second FRR object generated is configured to place labeled packets of the service LSP onto the tunnel 18 with an advertised next-next-hop service label. Local re-routing thus comprises dynamically selecting between activating the first FRR object and activating the second FRR object generated for each service LSP, based on whether the failure is a link failure or a node failure.

In some embodiments, the LSRs 12 are configured to propagate the above label advertisements amongst themselves responsive to establishment of the protection LSP tunnel 18, and to then locally generate the re-routing rules responsive to receipt of the label advertisements, Thus, as long as the protection LSP tunnel 18 is established in advance of a failure, the rules for intelligently using the tunnel 18 will also be established in advance of a failure.

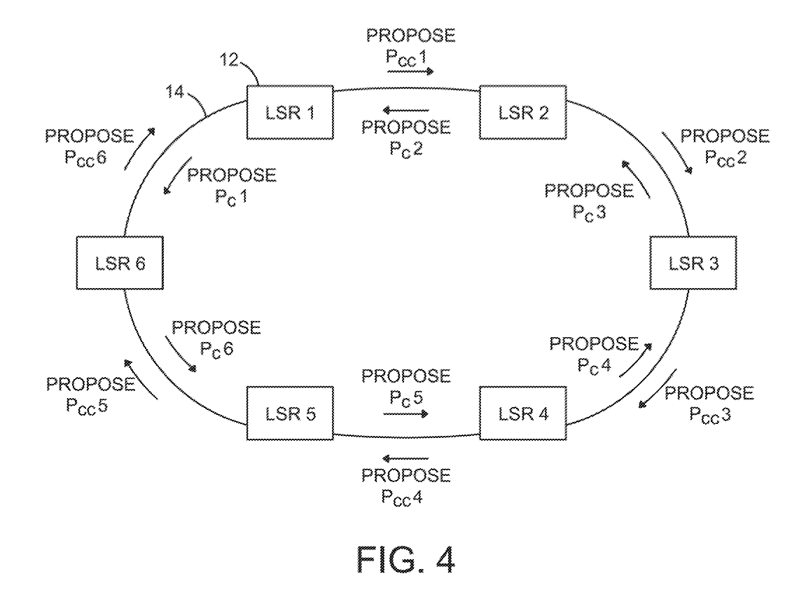

In this regard, the LSRs 12 in some embodiments are configured to automatically establish the tunnel 18 in advance of any failure, by locally coordinating with their neighbor LSRs usage of direction-specific protection labels for the tunnel 18. Such coordination may entail, for instance, exchanging protection label offers and responses with each neighbor LSR as shown in FIG. 4.

In FIG. 4, each LSR sends a protection label offer to each of its neighbor LSRs, A protection label offer sent by an LSR proposes a direction-specific protection label that can be used to send labeled packets to that LSR over the protection tunnel 18. LSR 1, for instance, sends a protection label offer to LSR 2 proposing that LSR 2 use protection label Pool in order to send labeled packets to LSR 1 over the protection tunnel 18. LSR 1 also sends a protection label offer to LSR 6 proposing that LSR 6 use protection label Pct in order to send labeled packets to LSR 1 over the protection tunnel 18.

Correspondingly, each LSR in FIG. 4 responds to a protection label offer received from each of its neighbor LSRs. The protection LSP tunnel 18 is established once negotiation of protection labels via offers and responses completes. Assuming that each of the LSRs 12 in FIG. 4 accepts received protection label offers, the protection LSP tunnel 18 is established as was illustrated in FIGS. 3A and 3B.

In some embodiments, automatic establishment of the tunnel 18 in this way is initiated by a particular LSR referred to as a designated LSR, The designated LSR initiates tunnel establishment by autonomously sending protection label offers to its neighbor LSRs. Those offers trigger each neighbor LSR to not only respond to the offer it received from the designated LSR, but to also send a protection label offer to its other neighbor LSR. in this way, the designated LSR initiates the propagation of protection label offers around the ring network 10.

For example, if LSR 6 in FIG. 4 is the designated router, that LSR autonomously sends protection label offers to LSR 1 and LSR 5 that respectively propose protection labels Pcc6 and Pc6 from its local label space. Responsive to receipt of the Pcc6 offer, LSR 1 responds to the offer and also sends a protection label offer to LSR 2 proposing protection label Pcc1 from its local label space. Likewise, responsive to receipt of the Pc6 offer, LSR 5 responds to the offer and also sends a protection label offer to LSR 4 proposing protection label Pc5. Protection label offers propagate around the ring network 10 in this way until finally LSR 1 proposes Pc1 to LSR 6 responsive to receiving the Pc2 offer from LSR 2, and LSR 5 proposes Pcc5 to LSR 6 responsive to receiving the Pcc4 offer from LSR 4.

In at least one embodiment, the LSRs 12 in the network 10 cooperatively elect the designated router based an predefined qualifications. One such qualification may simply be that the designated router has the highest router identifier among the LSRs 12 in the network. Regardless of the particular qualification, cooperative election may entail each LSR receiving and inspecting a message that indicates the highest qualifications of one or more LSRs already considered for designation. Each LSR selectively modifies the message to include its own qualifications, only if its qualifications are higher than the qualifications indicated in the message, and forwards the message to another LSR in the network 10. After the message has been propagated around the ring network 10 in this way, the message will identify the LSR that has the highest qualifications among the LSRs 12. An LSR may then inspect the message to determine whether or not it has been elected as the designated router to automatically initiate establishment of the tunnel 18.

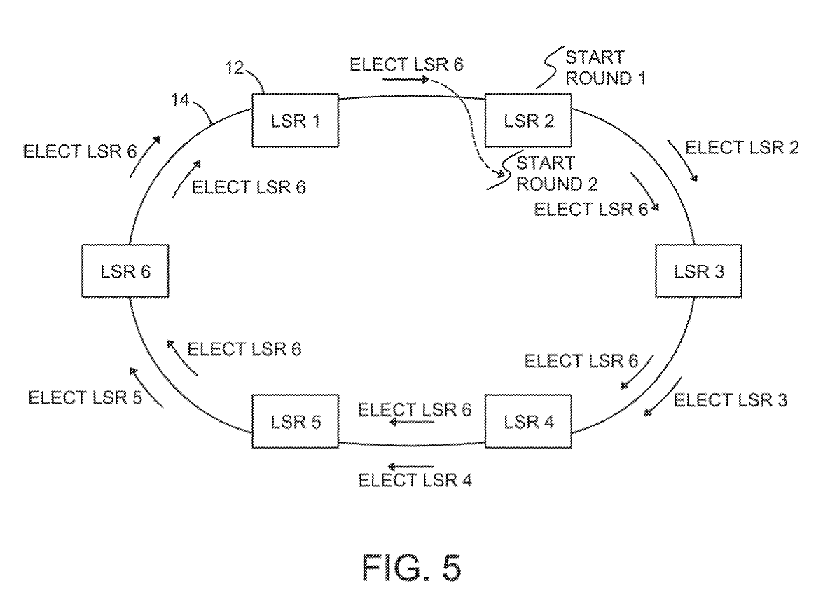

FIG. 5 illustrates a simple example of this cooperative election process where the predefined qualification for election is that the designated router have the highest router identifier among the LSRs 12 in the network 10. As shown in the example, LSR 2 starts the first round of the cooperative election process by sending a message to LSR 3 that indicates LSR 2 has the highest router identifier in the network 10. Upon inspecting the message, LSR 3 determines that it has a higher router identifier than the identifier indicated in the message (i.e., LSR 2). Accordingly, LSR 3 modifies the message to indicate that LSR 3 has the highest router identifier and then forwards the modified message to LSR 4. As this process continues, LSRs 4, 5, and 6 each modify the message to indicate that they have the highest router identifier. Finally, upon inspecting the message received from LSR 6, LSR 1 determines that it does not have a higher router identifier than the identifier indicated in the message (i.e., LSR 6). Thus, LSR 1 simply forwards the message to LSR 2 without modification, to start the second round of the cooperative election process. In this second round, each LSR inspects the received message to determine whether or not it has been elected as the designated router and then forwards the unmodified message on around the network 10. In this example, LSR 6 determines from the message that it has been elected as the designated router and correspondingly initiates establishment of the tunnel 18 as described above.

The various reports, advertisements, offers, responses, and messages described above may be communicated between LSRs 12 in the network 10 via any number of possible communication mechanisms. According to at least one embodiment, though, they are communicated within different types of protection coordination messages that are sent over the tunnel on an in-band control channel. As just one example of these embodiments, an LSR that has detected disconnection with a neighbor LSR monitors protection state coordination messages received over the tunnel on an in-band control channel for a particular type of message that is identified as a failure report.

Use of protection coordination messages and an in-band control channel proves to advantageously minimize the control signaling complexity involved in tunnel establishment, re-route rule generation, and local protection initiation Minimizing control signaling complexity in this way correspondingly reduces demands on LSR capabilities, so that the embodiments herein are sufficiently light-weight to be applied to low-end LSRs within an access network. Indeed, according to embodiments herein, LSRs need not even have the IP capabilities traditionally required to negotiate protection labels over a Resource Reservation Protocol (RSVP) session.

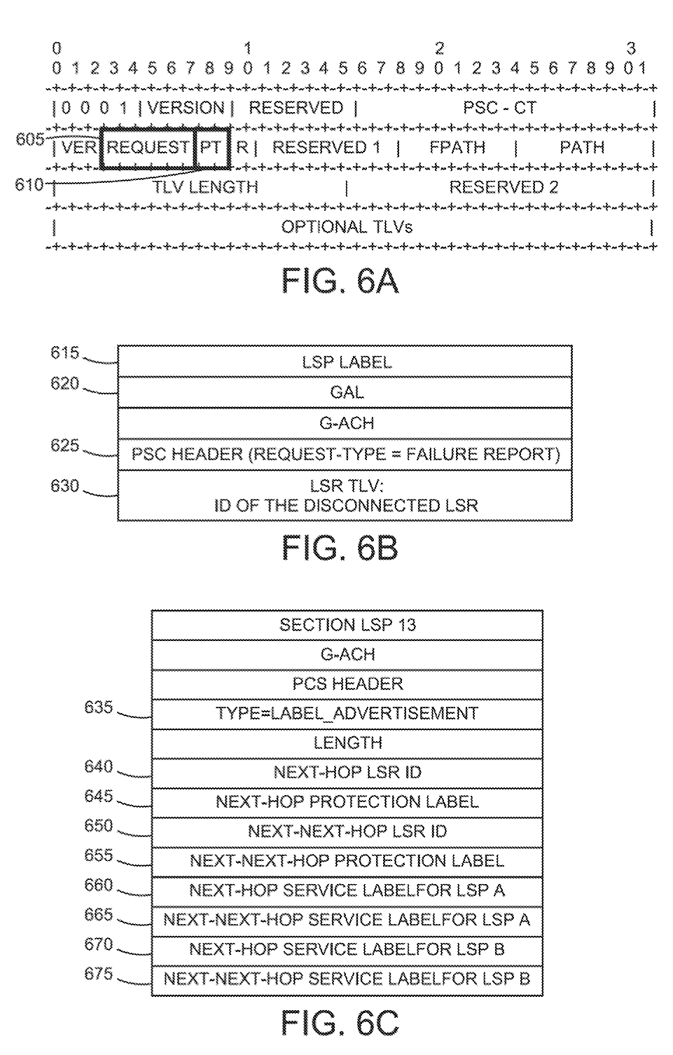

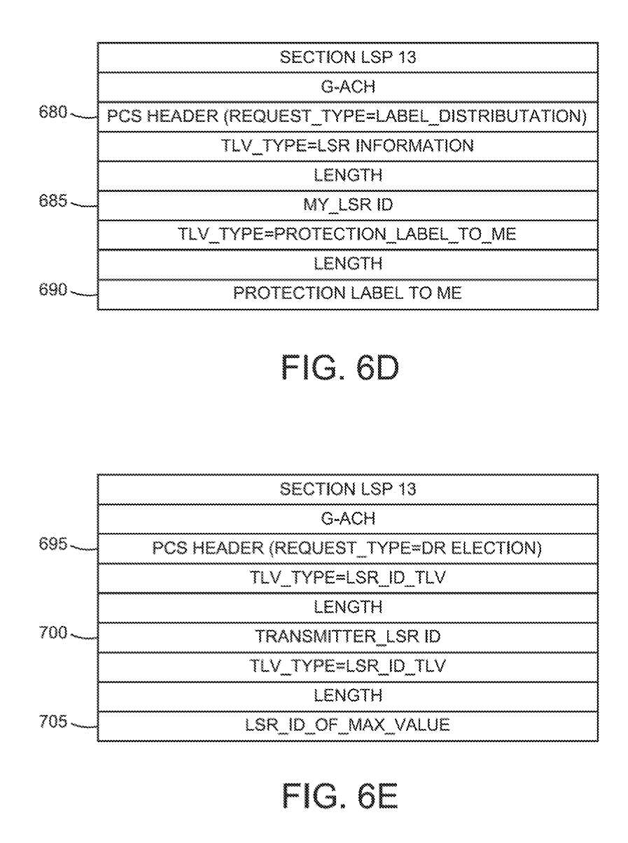

FIGS. 6A-6E illustrate an example of these advantageous embodiments in the context of MPLS-based networks. In this example, the in-band control channel is a Generic Associated Channel (G-ACH) that provides a logical control channel in the data plane and is identified by a reserved label 620 referred to as a G-ACH label (GAL) (where the GAL typically has a value of ‘13’). Further, protection coordination messages in this example are configured as an extension to conventional Protection State Coordination (PSC) protocol messages used to synchronize local protection decisions of LSRs.

FIG. 6A illustrates the header of a PSC protocol message according to one or more embodiments. The embodiments utilize reserved values of the Request field 605 and the PT field 610 to tailor the message to uses described above. In particular, embodiments use a reserved value of the Request field 605 (e.g., ‘00’) to identify that the PSC message is for protecting service LSPs of a ring network. Embodiments further use different reserved values of the PT field 610 to identify the PSC message as being either a failure report, a label advertisement, a protection label offer or response, or a designated router election message. FIGS. 6B-6E illustrate these different types of PSC messages in more detail.

FIG. 6B illustrates a labeled packet that conveys a particular type PSC message, namely a failure report. In embodiments where the PSC message is sent over the tunnel 18, the top LSP label 615 of the packet is a protection label. Intermediate LSRs 12 that have not detected disconnection with a neighbor LSR simply perform protection label switching with respect to this protection label 615 in order to blindly forward the packet around the ring network 10. However, an LSR 12 that has detected disconnection with a neighbor LSR monitors for a failure report by popping the protection label 615 of a received packet in order to determine whether the packet conveys G-ACH signaling, if the LSR 12 recognizes the underlying label as the GAL 620, the LSR 12 further inspects the PT field 610 of the PSC message header 625 conveyed, over the G-ACH to determine whether the PSC message is a failure report. if indeed the PSC message is a failure report, the LSR 12 inspects a type-length-value (TLV) element 630 in the report to determine the identifier of an LSR reported as disconnected. If the inspecting LSR determines that the reported identifier is its own identifier, then the LSR deduces that the link to its neighbor LSR has failed. Conversely, if the inspecting LSR determines that the reported identifier is the identifier of its neighbor LSR, then the LSR deduces that the neighbor LSR itself has failed.

FIG. 6C next illustrates a labeled packet that conveys another type of PSC message, namely a label advertisement Each LSR 12 monitors the G-ACH on the tunnel 18 for such label advertisement after the tunnel 18 has been established, by inspecting the PT field 610 of received PSC messages for the reserved value associated with a label advertisement 635. FIG. 6C illustrates the fields of the advertisement from the perspective of an LSR receiving the advertisement. From this perspective, the advertisement conveys identifiers 640 and 650 that are the identifiers of LSRs that are the next-hop and the next-next-hop LSRs in a particular direction. The advertisement further conveys the protection labels 645, 655 associated with those hops. The advertisement also includes fields indicating the next-hop and next-next-hop service labels for a number of service LSPs that are established in the particular direction (e.g., fields 660-675 for service LSPs A and B). With reference to FIGS. 3A and 3B, for instance, a label advertisement received by LSR 2 from LSR 3 would include a field 640 indicating LSR 3 as the next-hop LSR ID, a field 645 indicating Pc3 as the protection label associated with that hop, a field 650 indicating LSR 4 as the next-next-hop LSR ID, a field 655 indicating Pc4 as the protection label associated with that hop, a field 660 indicating A3 as the next-hop service label for LSP A, a field 665 indicating A4 as the next-next-hop service label for LSP A, a field 670 indicating B3 as the next-hop service label for LSP B, and a field 675 indicating B4 as the next-next-hop service label for LSP B.

FIG. 6D now illustrates a labeled packet that conveys yet another type of PSC message, namely a protection label offer. The offer includes a field 685 that indicates the identifier of the LSR making the offer, as well as a field 690 that indicates the protection label proposed for sending labeled packets over the tunnel to that LSR.

Finally, FIG. 6E illustrates a labeled packet that conveys a different type of PSC message, namely a designated router election message. The election message includes a field 700 that indicates the identifier of the LSR sending the message as well as a field 704 that indicates the identifier of the LSR with the highest qualifications for being the designated router.

Consistent with the advantage of minimizing control signaling complexity, one or more embodiments herein utilize Bidirectional Forwarding Detection (BFD) as the protocol for detecting disconnection with a neighbor LSR. In this case, an LSR detects disconnection with a neighbor LSR using a dedicated BDF session established on the link between the LSRs. When combined with the PSC embodiments just described, embodiments herein effectively associate a BDF session with PSC control signaling circuitry. Indeed, responsive to the BFD session detecting disconnection with a neighbor LSR, PSC control signaling circuitry sends a PSC message reporting the disconnection and correspondingly monitors for a PSC message that reports disconnection detected by another LSR.

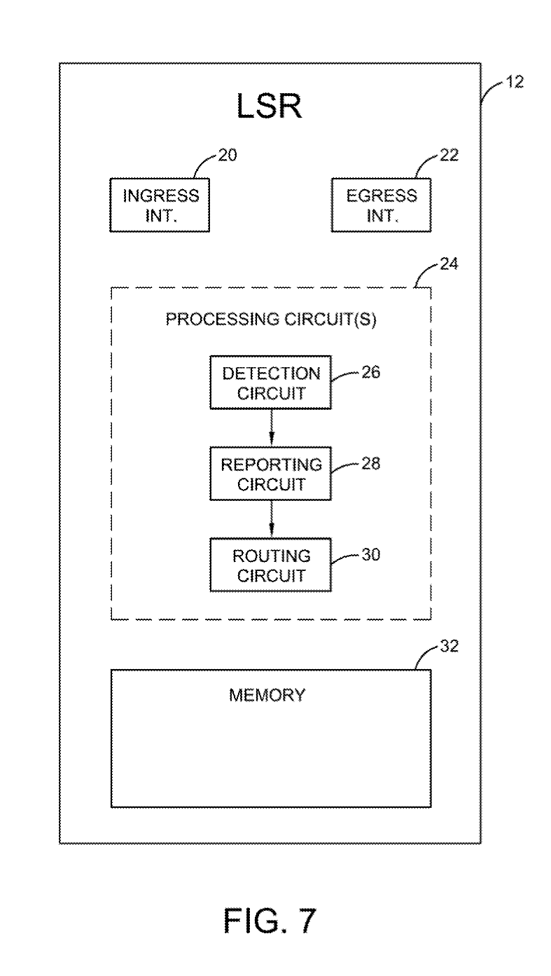

In view of the above modification and variations, those skilled in the art will appreciate that an LSR 12 in the ring network 10 (referred to as a first LSR for convenience) may be generally configured as shown in FIG. 7. In FIG. 7, the first LSR 12 includes an ingress interface 20 and an egress interface 22 that serve as one or more network interfaces for communication with other LSRs 12. The first LSR 12 further includes one or more processing circuits 24 configured to perform any of the methods described above. The one or more processing circuits 24 may implement the control and forwarding logic of the LSR 12. More specifically, the one or more processing circuits 24 may include a detection circuit 26, a reporting circuit 28, and a routing circuit 30.

The detection circuit 26 is configured to detect disconnection with a neighbor LSR 12. The reporting circuit 28 is configured, responsive to the detection circuit detecting disconnection with the neighbor LSR 12, to monitor for a report that either indirectly indicates failure of a link to the neighbor LSR 12 by reporting complementary disconnection with the first LSR 12 or indirectly indicates failure of the neighbor LSR 12 itself by confirming disconnection with the neighbor LSR 12. The reporting circuit 28 may also be configured, responsive to the detection circuit detecting disconnection with the neighbor LSR 12, to generate a report that reports disconnection with the neighbor LSR 12 and to send that report over the ring network 10 in a direction away from the failure.

Finally, the routing circuit 30 is configured, responsive to receiving the report, to locally re-route any labeled packets of service LSPs 16 headed toward the failure by placing those packets onto the tunnel 18 in a direction away from the failure. In this regard, the routing circuit 30 is configured to place the packets onto the tunnel 18 with either next-hop service labels or next-next-hop service labels depending on whether the failure is of the link or of the neighbor LSR 12. The routing circuit 30 is further configured, responsive to receiving the report, to locally merge any labeled packets received over the tunnel 18 into respective service LSPs 16 headed away from the failure.

Those skilled in the art will further appreciate that the various “circuits” just described may refer to a combination of analog and digital circuits, including one or more processors configured with software stored in memory 32 and/or firmware stored in memory 32 that, when executed by the one or more processors, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

Thus, those skilled in the art will recognize that the present invention may be carried out in other ways than those specifically set forth herein without departing from essential characteristics of the invention. The present embodiments are thus to be considered in all respects as illustrative and not restrictive, and ail changes corning within the meaning and equivalency range of the appended claims are intended to be embraced therein.

What is claimed is:

1. A method in a ring network of label switching routers (LSRs) for protecting multiple service label switched paths (LSPs) with a single bidirectional circular protection LSP tunnel established around the ring network in advance of any failure, wherein the method is implemented by a first LSR and is characterized by:
responsive to detecting disconnection with a neighbor LSR, monitoring for a report that either indirectly indicates failure of a link to the neighbor LSR by reporting complementary disconnection with the first LSR or indirectly indicates failure of the neighbor LSR itself by confirming disconnection with the neighbor LSR; and
responsive to receiving the report:
locally re-routing any labeled packets of service LSPs headed toward the failure by placing those packets onto the tunnel, in a direction away from the failure, with either next-hop service labels or next-next-hop service labels depending on whether the failure is of said link or of said neighbor LSR; and
locally merging any labeled packets received over the tunnel into respective service LSPs headed away from the failure.

2. The method of claim 1, further characterized by locally generating, in advance of any failure, re-routing rules that will govern said local re-routing, based on one or more label advertisements received from the neighbor LSR that advertise the next-hop service labels and next-next-hop service labels for the service LSPs.

3. The method of claim 2, wherein locally generating said re-routing rules comprises, for each service LSP, locally generating first and second Fast Re-Route (FRR) objects that are respectively configured to place labeled packets of the service LSP onto the tunnel with an advertized next-hop service label and an advertized next-next-hop service label for that service LSP, and wherein said re-routing comprises dynamically selecting between activating the first FRR object and activating the second FRR object generated for each service LSP, based on whether the failure is of said link or of said neighbor LSR.

4. The method of any of claims 2-3, further characterized by receiving the one or more label advertisements on an in-band control channel and within a protection coordination message.

5. The method of any of claims 1-4, wherein said monitoring comprises monitoring protection coordination messages received on an in-band control channel for the report.

6. The method of any of claims wherein said monitoring comprises monitoring the tunnel or the report.

7. The method of any of claims 1-6, further characterized by detecting disconnection with the neighbor LSR using a Bidirectional Forwarding Detection (BFD) session established on the link between the first LSR and the neighbor LSR.

8. The method of any of claims 1-7, further characterized by:
generating a report that reports disconnection with the neighbor LSR and that is generically targeted for any other LSR that has detected disconnection with one of its neighbor LSRs; and
sending the generated report over the ring network in a direction away from the failure.

9. The method of any of claims 1-8, further characterized by automatically establishing the tunnel in advance of any fault, by locally coordinating with each neighbor LSR usage of direction-specific protection labels for the tunnel.

10. The method of claim 9, wherein said locally coordinating comprises exchanging protection label offers and responses with each neighbor LSR within protection coordination messages and on an in-band control channel.

11. The method of any of claims 9-10, wherein said automatically establishing comprises cooperatively designating one of said LSRs to initiate said local coordination, based on predefined qualifications.

12. The method of claim 11, wherein said cooperatively designating comprises:
receiving and inspecting a message that indicates the highest qualifications of one or more LSRs already considered for designation;
selectively modifying the message to include the qualifications of the first LSR, if those qualifications are higher than the qualifications indicated in the message; and
forwarding the modified message to another LSR in the ring network.

13. The method of claim 12, wherein said message is received and forwarded within a protection coordination message on an in-band control channel.

14. The method of any of claims 1-13, wherein the ring network is a Multi-Protocol Label Switching based (MPLS-based) network.

15. A first label switching router (LSR) in a ring network of LSRs configured to protect multiple service label switched paths (LSPs) with a single bidirectional circular protection LSP tunnel established around the ring network in advance of any failure, wherein the first LSR comprises one or more network interfaces to neighbor LSRs and is characterized by one or more processing circuits configured to:
responsive to detecting disconnection with a neighbor LSR, monitor for a report that either indirectly indicates failure of a link to the neighbor LSR by reporting complementary disconnection with the first LSR or indirectly indicates failure of the neighbor LSR itself by confirming disconnection with the neighbor LSR; and
responsive to receiving the report:
locally re-route any labeled packets of service LSPs headed toward the failure by placing those packets onto the tunnel, in a direction away from the failure, with either next-hop service labels or next-next-hop service labels depending on whether the failure is of said link or of said neighbor LSR; and
locally merge any labeled packets received over the tunnel into respective service LSPs headed away from the failure.

16. The first LSR of claim 15, wherein the one or more processing circuits are further configured to locally generate, in advance of any failure, re-routing rules that will govern said local re-routing, based on one or more label advertisements received from the neighbor LSR that advertise the next-hop service labels and next-next-hop service labels for the service LSPs.

17. The first LSR of claim 16, wherein the one or more processing circuits are configured to locally generate said re-routing rules by, for each service LSP, locally generating first and second Fast Re-Route (FRR) objects that are respectively configured to place labeled packets of the service LSP onto the tunnel with an advertized next-hop service label and an advertized next-next-hop service label for that service LSP, and to perform said local re-routing by dynamically selecting between activating the first FRR object and activating the second FRR object generated for each service LSP, based on whether the failure is of said link or of said neighbor LSR.

18. The first LSR of any of claims 16-17, wherein the one or more processing circuits are further configured to receive, via the one or more network interfaces, the one or more label advertisements on an in-band control channel and within a protection coordination message.

19. The first LSR of any of claims 15-18, wherein the one or more processing circuits are configured to monitor protection coordination messages received on an in-band control channel for the report.

20. The first LSR of any of claims 15-19, wherein the one or more processing circuits are configured to monitor the tunnel for the report.

21. The first LSR of any of claims 15-20, wherein the one or more processing circuits are configured to detect disconnection with the neighbor LSR using a Bidirectional Forwarding Detection (BFD) session established on the link between the first LSR and the neighbor LSR.

22. The first LSR of any of claims 15-21, wherein the one or n e processing circuits are further configured to.
generate a report that reports disconnection with the neighbor LSR and that is generically targeted for any other LSR that has detected disconnection with one of its neighbor LSRs; and
send the generated report, via the one or more network interfaces, over he ring n work in a direction away from the failure.

23. The first LSR of any of claims 15-22, wherein the one or more processing circuits are further configured to automatically establish the tunnel in advance of any fault, by locally coordinating with each neighbor LSR usage of direction-specific protection labels for the tunnel.

24. The first LSR of claim 23, wherein the one or more processing circuits are configured to locally coordinate with each neighbor LSR by exchanging protection label offers and responses with each neighbor LSR within protection coordination messages and on an in-band control channel.

25. The first LSR of any of claims 23-24, wherein the one or more processing circuits are configured to automatically establish the tunnel by cooperatively designating one of said LSRs to initiate said local coordination, based on predefined qualifications.

26. The first LSR of claim 25, wherein the one or more processing circuits are configured to cooperatively designate one of said LSRs by:
receiving and inspecting a message that indicates the highest qualifications of one or more LSRs already considered for designation:
selectively modifying the message to include the qualifications of the first LSR, if those qualifications are higher than the qualifications indicated in the message; and
forwarding the modified message to another LSR in the ring network.

27. The first LSR of claim 26, wherein said message is received and forwarded within a protection coordination message on an in-band control channel.

28. The first LSR of any of claims 15-27, wherein the ring network is a Multi-Protocol Label Switching based (MPLS-based) network.
